(19) United States
(12) Patent Application Publication
(10) Pub. No.: US 2022/0044181 A1
(43) Pub. Date: Feb. 10, 2022

(54) System and Method for Crop Management

(71) Applicant: Sostena, Inc., EL MACERO, CA (US)

(72) Inventors: Timothy X. Colin, El Macero (US); Tyler Colin, El Macero (US)

(73) Assignee: Sostena, Inc., EL MACERO, CA (US)

(21) Appl. No.: 17/410,235

(22) Filed: Aug. 24, 2021

Related U.S. Application Data
(62) Division of application No. 15/641,004, filed on Jul. 3, 2017, now abandoned.
(60) Provisional application No. 62/358,263, filed on Jul. 5, 2016.

(51) Int. Cl. G06Q 10/06; G06Q 50/02

(52) U.S. Cl. CPC G06Q 10/06375; A01B 79/005; G06Q 50/02; G06Q 10/06

(57) ABSTRACT

A system and method for crop management uses data of specific varieties, such as the effect of growing degree units (GDU) on the phenological stage and optimal soil moisture percentage (SMP) to predict crop growth, to water the crops, and to manage agricultural systems by suggesting planting dates required to meet harvest goals. For plants growing in irrigation tracts, the system and method may use soil moisture sensors and the phenological stage information to provide water to the plants. In other embodiments, predictions are made of harvest dates for planted varieties and/or planting dates to reach harvest goals. The effect of mulching may be taken into account.

### CROSS-REFERENCE TO RELATED APPLICATIONS

This application claims the benefit of U.S. Provisional Application No. 62/358,263, filed Jul. 5, 2016, the contents of which are hereby incorporated by reference in its entirety.

### BACKGROUND OF THE INVENTION

### FIELD OF THE INVENTION

The present invention relates generally to agriculture and, more particularly, to a method and system for managing crops.

### DISCUSSION OF THE BACKGROUND

Maximizing agricultural resources is greatly facilitated by being able to accurately determine when fields will be ready for harvest. Thus, for example, chain stores and national restaurant exchanges would like to be able to secure supplies of produce over some period of time, such as, for example, setting a delivery schedule of a certain size of watermelons every week over a several month period. This may require several plantings and also several harvests for each field to meet the demand.

Given that the time to harvest depends on the weather and features of specific varieties of plants, it may be difficult to fulfill previously specified orders. Thus, it is difficult for a farmer to produce, for example, a weekly supply of watermelons. As a result, there may be overproduction at some times, requiring that other buyers be found, likely at a lower price, and/or underproduction, which disrupts the supply chain of the produce for the buyer.

While farmers do have guidelines that they follow, the results are variable. There is a need for a system that allows farmers to better plan when to plant crops and how to tend the crops so that they can be harvested at some required time in the future. Such a system should provide predictive capabilities of when harvests will occur and aid or control the watering or other aspects of crop tending to better ensure that harvest goals are met.

In addition, there is a long supply chain between growers and individual stores, including vendors who arrange for shipping of the produce from the field and buyers who accept the vendor's shipments and distribute the produce to individual stores. It is well established that as much as 40% of all produce crops never make it to the table. One of the contributing factors to this inefficiency is a lack of transparency and certainty that prevents coordination among the various supply chain stakeholders who contribute to produce traveling from field to fork. There is a need for a system that allows the various stakeholders to be aware of estimated and actual harvest dates to allow for better resource planning and for making sure that they receive produce according to schedule.

Either system should be easy to implement, require a minimal amount of input from the farmer, and, optionally, be able to handle complex harvest goals.

### BRIEF SUMMARY OF THE INVENTION

The present invention overcomes the disadvantages of prior art by using phenological growth data and historical and/or predicted weather data for crop management.

In certain embodiments, a method is provided for calculating a grower's transplant date for a particular crop that will result in a desired harvest date and a method of calculating and recalculating a grower's projected harvest date on an ongoing basis using historical temperature data, including such data collected since the planting date and making that calculated projected harvest date available to stakeholders.

In certain other embodiments, an apparatus is provided for calculating a grower's transplant date for a particular crop that will result in a desired harvest date and for calculating and recalculating a grower's projected harvest date on an ongoing basis using historical temperature data, including such data collected since the planting date and making that calculated projected harvest date available to stakeholders.

In yet other embodiments, a method of crop management of a plant variety to be planted at a geographic location using predicted temperature data for the geographic location is provided. The method includes: accepting a harvest date corresponding to the beginning of the phenological harvesting stage of the plant variety; and determining a transplant date corresponding to the accepted harvest date and the predicted temperature data, where the determined transplant date results in the number of growing degree units from the determined transplant date to the accepted harvest date being equal to a predetermined value, GDUH.

In yet another embodiment, an apparatus for crop management of a plant variety to be planted at a geographic location is provided. The apparatus includes a computer having a processor programmed to: accept predicted temperature data for the geographic location; accept a harvest date corresponding to the beginning of the phenological harvesting stage of the plant variety; and determine a transplant date corresponding to the accepted harvest date and the predicted temperature data, where the determined transplant date results in the number of growing degree units from the determined transplant date to the accepted harvest date being equal to a predetermined value, GDUH.

In certain embodiments, a method of crop management of a plant variety at a geographic location is provided. The method includes: transplanting the plant variety on a transplant date, where the plant variety has a predetermined value of the number of growing degree units from the transplant date to the beginning of the phenological harvesting stage of GDUw, for a current date after the transplant date, updating an estimate of the harvest date as the date where the number of growing degree units using historical temperature data at the geographic location from the transplant date to the current date and using predicted temperature data at dates after the current date is equal to GDUH; and reporting the updated harvest date.

In certain other embodiments, an apparatus for crop management of a plant variety at a geographic location is provided. The apparatus includes a computer having a processor programmed to: accept a transplant date for the plant variety, where the plant variety has a predetermined value of the number of growing degree units from the transplant date to the beginning of the phenological harvesting stage of GDUH; for a current date after the transplant date, update an estimate of the harvest date as the date where the number of growing degree units using historical temperature data at the geographic location from the transplant date to the current date and using predicted temperature data at dates after the current date is equal to GDUH; and report the updated harvest date.

These features, together with the various ancillary provisions and features which will become apparent to those skilled in the art from the following detailed description, are attained by the method and system of the present invention, preferred embodiments thereof being shown with reference to the accompanying drawings.

### BRIEF DESCRIPTION OF THE DRAWINGS

FIG. 1 is a schematic diagram of a system for assisting a grower in the production of crops;

FIG. 2 illustrates electronic device and server as standard digital computing devices;

FIG. 3 is a schematic diagram of a first embodiment system of FIG. 1;

FIG. 4 is a schematic diagram of a process executed in the prediction module;

FIG. 5 illustrates one embodiment of the harvest optimization module;

FIG. 6 is an example of a screenshot showing user input for a field including the block name, commodity, variety, pollinator, transplant date, acreage, plants per acre, whether the block is mulched and the number of added heat units for the mulched crops, and the system output including predicted harvest date for harvest #1 and harvest #2; and

FIG. 7 is an example of a screenshot showing prompts and input to suggest transplant dates to meet harvest goals.

Reference symbols are used in the Figures to indicate certain components, aspects or features shown therein, with reference symbols common to more than one Figure indicating like components, aspects or features shown therein.

### DETAILED DESCRIPTION OF THE INVENTION

In certain embodiments, systems include a computer that, given a planting date and information on the farm location and plant variety planted, estimates a harvest date based on weather predictions and then provides updated harvest date estimates thereafter.

In certain other embodiments, systems include a computer that, given a desired harvest date and harvest yield and information on the farm location and plant variety planted, provides a planting schedule and, for certain crops, a harvesting schedule based on weather predictions, and then provides updated harvest date estimates thereafter.

In either of these cases, the system may also include a model that tends to certain aspects of the growing of the crops, such as watering, in light of the actual weather to ensure the highest yield In addition, the model is capable, under certain circumstances, of adjusting the watering to speed up or delay the harvest dates as the result of differences between the predicted and actual weather. Thus, for example, adjusting the watering of plants during growth can effectively adjust the growing of the plants to maintain or to attempt to maintain the targeted harvest dates.

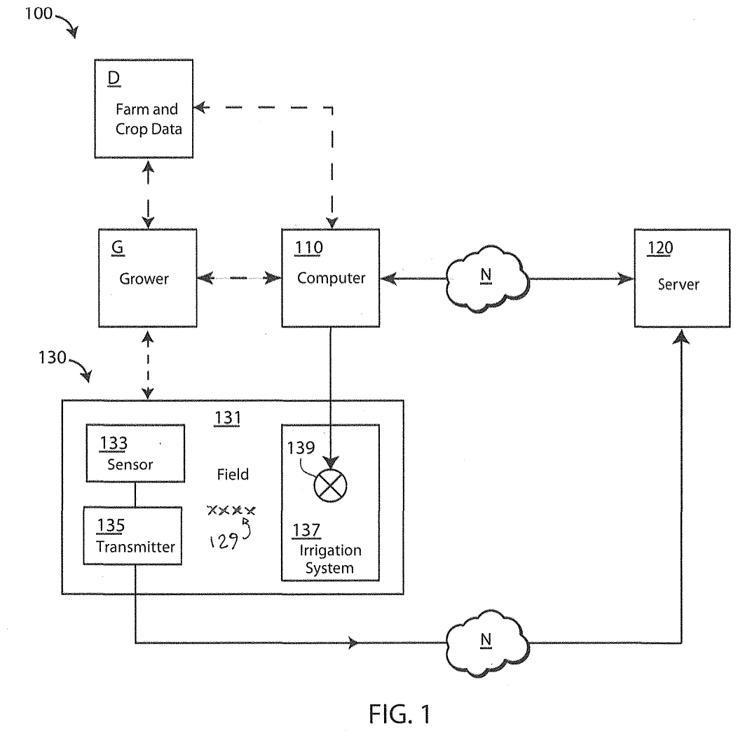

FIG. 1 is a schematic diagram of a system 100 for assisting a grower G in the production of crops 129 in a farm 130 having a field 131 with a moisture sensor 133 and corresponding sensor output transmitter 135, and an irrigation system 137 having one or more valves 139 which is operable to provide water to the field 131. Alternative embodiments may include a farm 130 with two or more fields 131 or irrigation tracts, each with its own moisture sensor 133 and valves 139 for watering the associated field. In general, system 100 has access to historical and predicted information that the system uses to facilitate the growing of crops 129 to maturation.

System 100 includes: an electronic device 110 for use by grower G, where the electronic device may be, for example and without limitation, a desktop or portable computer, a cellular telephone, a portable digital assistant, a tablet or some other computing device; an irrigation system 137 having valves 139 in communication with and controlled by the electronic device or other devices of the system; sensor 133 and corresponding sensor output transmitter 135 located in the field 131; and a server 120 that is in communication over network N with the computer 110 and transmitter 135. As shown by the dashed lines in FIG. 1, grower G has access to farm and crop data D, operates electronic device 110, and can periodically check on the crops 129 in field 121 and report (input) this information to the electronic device. In an alternative embodiment, instructions for irrigation system 137 are provided to grower G on electronic device 110 or another device of system 100, and valves 139 are controlled manually to operate the irrigation system 137.

In general, grower G and/or system 100 determine a planting schedule of crops 129 for field 131. In certain embodiments, the grower G utilizes farm and crop data D to determine a planting schedule for field 131, and the planting schedule is then input to electronic device 110 and/or server 120. Farm and crop data D may include but is not limited to irrigation tract size, tract location, sensor ID number, soil conditions, and whether the soil is mulched, and crop data which may include but is not limited to the variety of plants to be grown, transplant dates, and target harvest dates. In certain embodiments, some or all of the information of farm and crop data D is included in or is provided to electronic device 110 and/or server 120.

In certain embodiments, system 100 may be used to provide one or more of the following: estimated harvest dates, estimated harvest yields, and planting schedules. In certain other embodiments, system 100 uses information related to optimal plant growth to operate an irrigation system or to instruct grower G how and when to water crops.

Thus, for example, grower G may, by using device 110, provide server 120 with desired selections or specifications on what produce is required from field 131. Server 120 may use this information to provide device 110 (and thus grower G) with suggestions, options and/or predictions on planting or harvesting produce.

Certain embodiments include having grower G, either prompted or unprompted, inspect field 121 to determine the phenological stage of plant growth, which is referred to herein as “phenological stage” or “stage”, and provided as input to system 100.

The stages, as used herein, are defined as but are not limited to: 1) transplant stage; 2) plant developing stage; 3) fruit setting stage; 4) fruit development stage; and 5) harvesting stage.

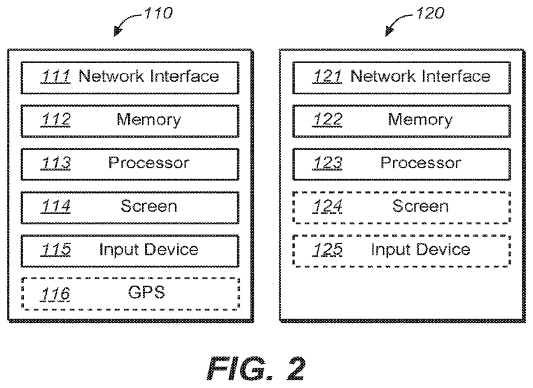

FIG. 2 illustrates electronic device 110 and server 120 as standard digital computing devices that each include their own network interface 111/121 for communicating over network N, non-transitory computer readable memory 112/122 for storing programming and data, and a processor 113/123 that can operate off of programming stored in the device's respective memory. Computer 110 includes a screen 114, an input device 115 and, optionally, Global Positioning System (GPS) hardware 116. Server 120 optionally includes a screen 124 and an input device 125.

In general, server 120 is adapted for providing information, which may be web services, to device 110 over network N as is known in the art. Thus, server 120 and device 110 utilize their respective network interface for communicating over the network and their respective memory for providing operating instructions to their respective processor. Network interfaces 111/121 are used for two-way communication between device 110 and server 120 over a wireless network, which may include, but is not limited to, a cellular telephone network, a WiFi network, a public switched telephone network (P S TN), and the Internet. Memory 112/122 includes programming required to operate device 110 and server 120 (such as an operating system or virtual machine instructions), and may include portions that store information or programming instructions obtained over network N. In one embodiment, screen 114 and input device 115 is a touch screen providing the functions of display and input.

Irrigation system 137 includes remotely operated valves 139 which, when operated, provide water to field 131. Valves 139 are, for example, solenoid valves for controlling the flow of water, which are known in the field.

Field 131 is provided with a sensor 133 that, through transmitter 135, wirelessly reports soil moisture to server 120. Sensor 133 is used to measure moisture in the vicinity of the growing plants. Sensor 133 may include, for example, commonly used sensors for measuring the Volumetric Water Content (VWC) of the soil, which is the ratio of the volume of water in a soil sample V_{w}, to the total volume of wet soil V_{wet} which is the sum of the volume of the soil, organic matter, water and air in a soil sample.

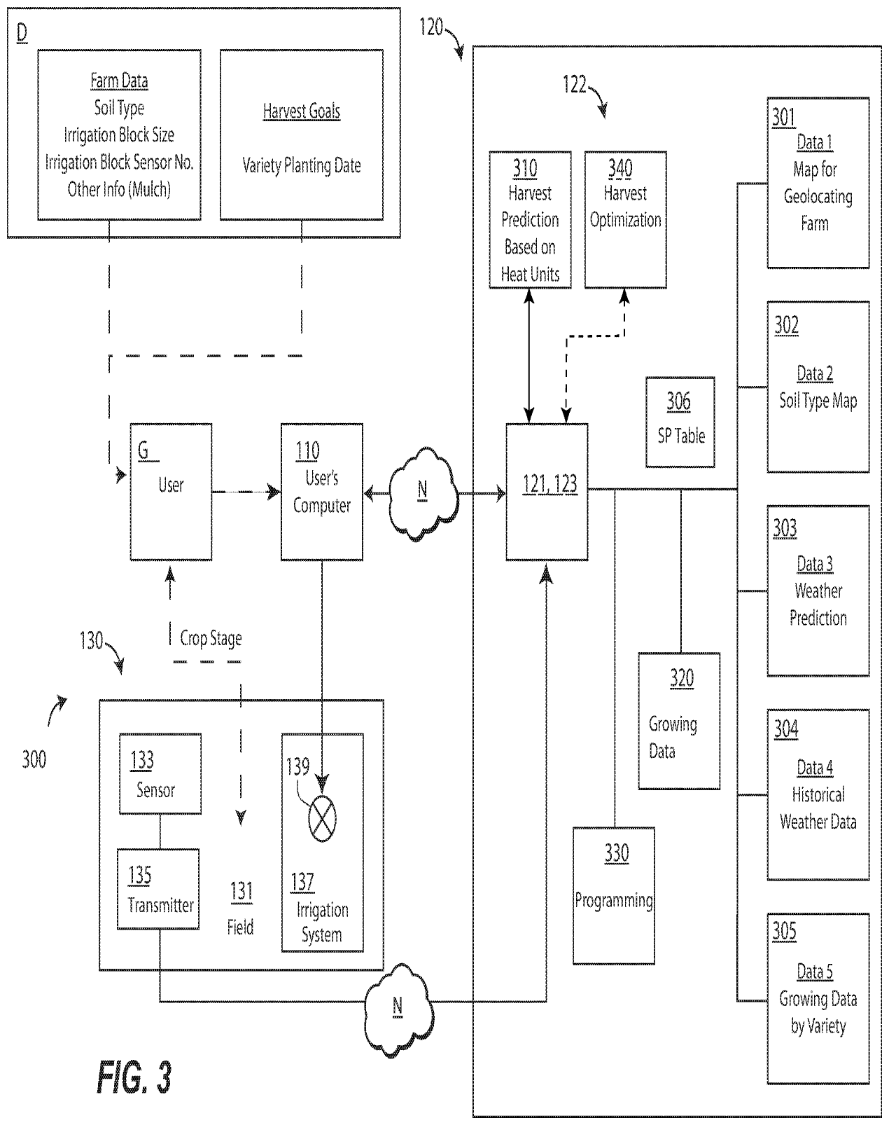

FIG. 3 is a schematic diagram of system 100 as a first embodiment system 300 that is generally similar to system 100, except as explicitly stated.

In system 300, electronic device 110 that, in combination with server 120, is used by grower G to input information that may include, for example and without limitation: details of the farm land on which crops are to be grown; details regarding the planting date and plant specifics such as the plant variety of crops that have been or will be planted; and, optionally, periodic reporting on the stage of plant growth. Electronic device 110 reports back to grower G, for example and without limitation: harvest prediction dates and watering instructions for valves 139 of irrigation system 137; and electronic communications to the irrigation system for watering crops.

As one example, electronic device 110 and server 120 include programming in memory 112 and 122, respectively, that, through network interfaces 111 and 121, respectively, displays information on screen 114 in the form of web pages, and which solicits input from input device 115 from grower G.

In addition, server 120 includes in memory 122 programming 330 that allows processor 123 to access various programming instructions or data which may include but is not limited to: harvest prediction module 310; a growing data module 320 that contains information on crops to be grown or that are currently growing; and modules to calculate or obtain data from databases regarding geographic location data module 301, soil type data module 302, weather prediction data module 303 to provide weather prediction data, historical weather data module 304 to provide actual previous temperature data, a variety growing data module 305, a saturation percentage module 306, and an optional harvest optimization module 340. Modules 310, 320, 301, 302, 303, 304, 305, 306, and 340 may reside on server 120 or may, through network interfaces 111 and/or 121 be on other networked computers (not shown) accessible over network

N.

Geographic location data module 301 includes a map or provides access to a web accessible map that server 120 may use to identify the geographic locations of tracts. There are several web services for obtaining geographic locations from maps such as Google Earth.

Soil type data module 302 is a database or provides access to a web accessible database of the type of soil for the tract. Examples of such data include but are not limited to the Web Soil Survey provided by the US Department of Agriculture. Alternatively, grower G may input data from farm and crop data D that is then stored in soil type data module 302.

Thus, for example, the input of a geographic location (from geographic location data module 301 or from farm and crop data D) may return a soil type that may be, for example and without limitation, sand, silt, clay, peat, or saline soil. Alternatively, the soil type may be contained in farm and crop data D and is inputted by grower G into soil type data module 302.

Soil type data module 302 may also include values of the saturation percentage (SP) of various types of soils. The SP is given by SP=100 V_{w}/V_{d}, where V_{w} is the ratio of the maximum volume of water that can be added to saturate dry soil and V_{d} is the volume of fully dried soil. Thus, for example, it is well known that the SP of sandy loam is from 20-35 of loam, or silt, loam is from 35-50, of clay, loam is from 50-65. Alternatively, values of SP may be from measurement of the actual soil in field 131 as stored in farm and crop data D.

Weather prediction data module 303 provides access to web accessible predictions of the weather at each tract's geographic location and may include, for example and without limitation, predictions of temperature, humidity, and/or cloud cover extending out to a harvest date (that is, covering the remaining period of interest for the development of the crops). Examples of such data include but are not limited to the Numerical Weather Prediction (NWP) service provided by the US National Oceanic and Atmospheric Administration.

Historical weather data module 304 is a database or provides access to a web accessible database that provides historical weather data at each tract's geographic location which may include, for example and without limitation, historical temperature, humidity, and/or cloud cover. Examples of such data include but are not limited to data provided by National Climate Data Center services provided by the US National Oceanic and Atmospheric Administration.

Saturation module 306 is used by system 300 to calculate values of soil moisture percentage SMP from data provided by sensors 133. The SMP is given by SMP 100 (V_{w}/V_{d}) where V_{w} is volume of water in a soil sample and V_{d} is the volume of fully dried soil. The data from sensors 133 is typically the VWC of the soil that, as noted above, is the ratio of the volume of water in a soil sample, V_{w} to the total volume of wet soil V_{wet}. Saturation module 306 thus divides values of VWC from sensors 133 and by values of SP obtained from that, is SMP=VWC/SP.

Variety growing data module 305 is a database or provides access to a web accessible database of information for each plant variety in field 131. The information includes experimentally determined measures of plant growth at each stage and may also account for multiple cuttings during the harvesting stage. Other stored or accessible information may include but is not limited to predicted harvest yield at each cutting, preferred soil moisture content for each stage, and the types of weather events that may disrupt or delay a stage.

In one embodiment, variety growing data module 305 includes, for example and without limitation, a measure of predicted stage as a function of temperature data that may be predicted temperature for plants not yet planted or may include predicted and historical data for plants which are in the process of being grown.

One useful measure of plant development that may be included in variety growing data module 305 is the number of growing degree units (GDU) for a plant in each stage. The GDU is also known as growing degree days (GDD). The use of GDU is a known heuristic tool in plant phenology and is a measure of heat accumulation by the plant during each stage that allows prediction of plant development rates including by not limited to the date that a flower will bloom or a crop will reach maturity.

For each day that a plant grows, that day's GDU is the average of the daily maximum and minimum temperatures in degrees C. compared to a threshold or base temperature T_{base}, (usually 10° C.) over a 24-hour period. Thus, for example, for each day of growth i, that day's GDU, or GDUᵢ, may be calculated as: GDUᵢ=(T_{max,i}+T_{min,i})/2−T_{base}, if the average temperature ((T_{max,i}+T_{min,i})/2) is greater than T_{base} or zero if the average temperature is less than T_{base}. Alternatively, this calculation may be written as

$$G D {U}_{i} = \{ \begin{matrix}\frac{{T}_{max , i} + {T}_{min , i}}{2} - {T}_{base} , & if ( \frac{{T}_{max , i} + {T}_{min , i}}{2} ) > {T}_{b a s e} \\ 0 , & if ( \frac{{T}_{max , i} + {T}_{min , i}}{2} ) \leq {T}_{b a s e}\end{matrix} .$$

The total GDU is the sum of each day's GDU, from the planting or transplant date of the crop to the current day I or

$$G D U = {{\sum }_{i = 0}}^{I} {GDU}_{i} .$$

The variety growing data module 305 may include or has access to a table of the number of GDUs required for a variety to reach each stage. The data may be either:1) the GDU for the plant to develop from transplant to the beginning of a particular stage; or 2) an incremental GDU (AGDU), which is the number of GDUs for the plant to develop through a particular stage.

In one embodiment, the measure of soil moisture is SMP. While data on GDU is well known and may be obtained from the sellers of the plant variety, the values of SMP are not generally well known and may require obtaining data from crops grown under controlled conditions to determine SMP for each stage.

As one example of variety growing data module 305, Table I illustrates typical module data for a specific variety of watermelon.

TABLE 1

| | | GDU at start of | Threshold | |
|---|---|---|---|---|
| | Harvest | stage | Temperature | |
| Phenological Stage | Yield | (target GDU) | (T_{base}) | SMP (%) |
| Transplant | — | 0 | 55° F. | 45-55 |
| Plant Developing | — | 1000 | 55° F. | 70-80 |
| Fruit Setting | — | 1200 | 55° F. | 60-65 |
| Fruit Development | — | 1300 | 55° F. | 70-80 |
| Harvesting - 1st Cut | 75% | 1400 | 55° F. | 70-75 |
| Harvesting - 2nd Cut | 25% | 1500 | 55° F. | 70-75 |

Thus, for this variety of plant, the threshold temperature, T_{base} which is used in the calculation of GDU is 55° F. for all stages. As the plant develops, the transplant stage is from GDU of 0 to 1000 and has a preferred SMP from 45%-55%, the plant developing stage is from GDU of 1000 to 1200 and has a preferred SMP from 70%-80%, the fruit setting stage is from GDU of 1200 to 1300 and has a preferred SMP of 60%-65%, the fruit development stage is from GDU of 1300 to 1400 and has a preferred SMP of 70%-80%, the Harvest stage has a first cut which harvests 75% of the crop, starts at a GDU of 1400 and has a preferred SMP of 70%-75% and the Harvest stage has a second cut which harvests 25% of the crop, starts at a GDU of 1500 and has a preferred SMP of 70%-80%.

Current crop data module 320 includes information on the crops in field 131 which may include but is not limited to for each tract: tract location, soil type, if the soil is mulched and a GDU correction factor M, and SP; the varieties and number of plants; and planting date(s), and, as a function of time since the planting date: the phenological stage of plant development; the number of heat units; and a predicted harvest date.

Thus, for example, using input device 115, electronic device is presented with a series of web pages on screen 114 through communication with server 120 and programming 330. In one embodiment, electronic device 110 is presented with a logon screen to obtain user information, a setup screen to input the various tracts geographic information, including but not limited to identification of the block location, size, soil type, irrigation block sensor identification number, and if the tract is mulched. System 300 then performs one or more of the following: 1) determining if the soil moisture level is suboptimal and providing instructions to the grower to water the crops or provides instructions to electronic device 110 which controls irrigation system 137 to water the crops; and 2) predicting a harvest data using prediction module 310.

System 300 may determine the need for watering the crops as follows. Programming 330 instructs server 120 to obtain data from sensor 133 and stores the data in growing data module 320. As noted above, system 300 provides watering instructions based on the current value of SMP. For sensors 133 that measure VWC, programming 330 then causes server 120 to receive the value of VWC from sensor 133, determine the soil type from growing data module 320 or from geographic location data module 301 and soil type data module 302, and, using saturation percentage module 306 obtain the value of SP, and then divide VWC by SP to obtain SMP and store a time-stamped value of SMP in growing data module 320.

Next, programming 330 instructs server 120 to determine if watering is necessary. The latest phenological stage and crop variety is retrieved from growing data module 320 and the optimal SMP for the current phenological stage is retrieved from variety growing data module 305. If the value of SMP is less than the optimal SNIP, then server 120: 1) sends a warning message to screen 114 instructing grower G that the field needs watering, and/or 2) sends a message to electronic device 110 to activate irrigation system 137 which then waters the corresponding irrigation tract.

In one embodiment, programming 330 periodically instructs server 120 to prompt grower G to inspect field 121 and report back on the phenological stage of the crops. Thus, for example, screen 114 may be provided with a prompt requesting that a current phenological stage be entered by grower G that is stored along with a time stamp in growing data module 320. In this embodiment, the stage obtained from inspection is used to override the predicted stage based on GDD.

In another embodiment, predicting a harvest date of plants in field 131 is accomplished using prediction module 310 which uses one or more modules 320, 301, 302, 303, 304, 305, or 306 and user input from electronic device 110 to predict harvest dates.

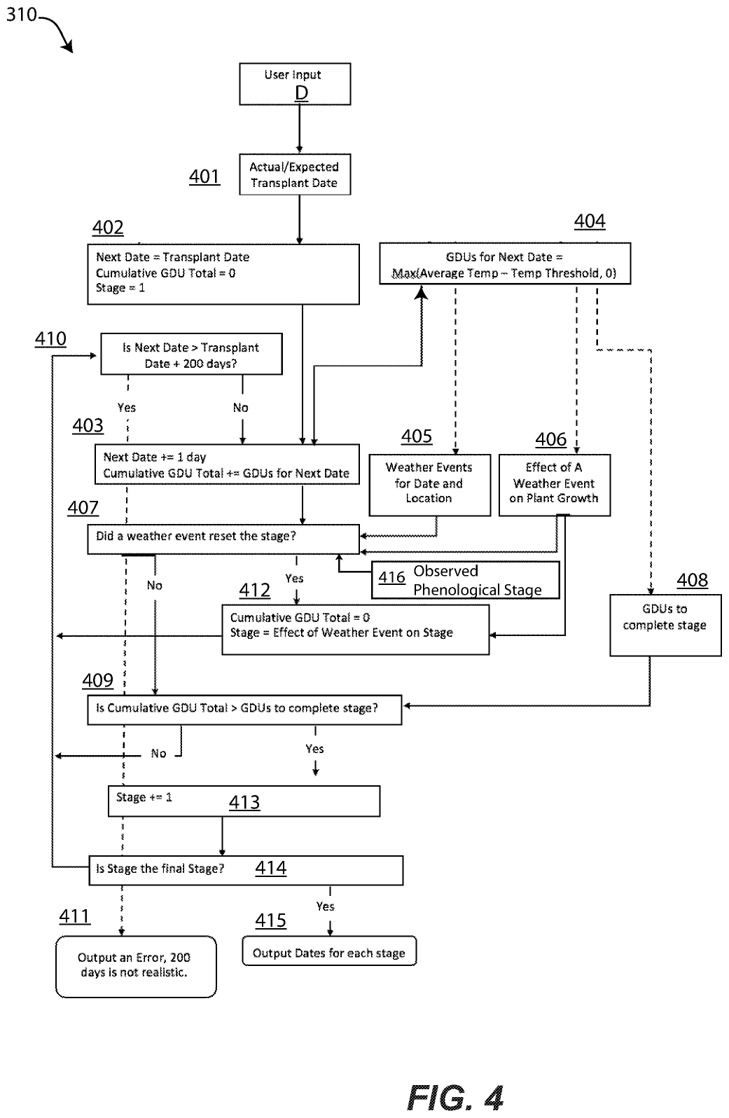

FIG. 4 is a schematic diagram of a process executed in prediction module 310.

Prediction module 310 obtains, in Block 401, an actual or expected transplant date that is obtained in programming 330, causing screen 114 to prompt for this information and to accept a date from input device 115. In Block 402, the phenological stage is initiated as the transplant stage and the value of GDU is initialized—that is, GDU=0 on the transplant date (i=0). In the following discussion of prediction module 310, system 300 tracks for the calculation date (starting with the transplant date) the stage and the GDU.

Prediction module 310 may calculate the GDU for each day, as described above. Alternatively, the effect of mulching the soil may be accounted for. The GDU for each stage (as in Table I) is generally obtained for unmulched crops. The effect of mulching is to retain moisture and heat in the ground. One way of accounting for mulching is to modify the calculation of GDU by increasing the value a certain number of heat units. This modified GDU, which is the GDU corrected for munching, will be denoted herein as GDUM. Thus, for example, mulch may effectively increase the heat retained by the plant by M for each day. Thus, the value of GDUᵢ is increased by a value M for each day's growth, and GDUMᵢ=M+(T_{max,i}+T_{min,i})/2−T_{base}, if the value of (M+(T_{max,i}+T_{min,i})/2) is greater than T_{base}, or zero, if (M+(T_{max,i} +T_{min,i})/2) is less than T_{base}. Alternatively, this calculation may be written as

$$G D U {M}_{i} = \{ \begin{matrix}M + \frac{{T}_{max , i} + {T}_{min , i}}{2} - {T}_{base} , & if M + ( \frac{{T}_{max , i} + {T}_{min , i}}{2} ) > {T}_{b a s e} \\ 0 , & if M + ( \frac{{T}_{max , i} + {T}_{min , i}}{2} ) \leq {T}_{b a s e}\end{matrix} .$$

The total GDUM is the sum of each day's GDUM1from the planting or transplant date of the crop to the current day, I, or

$$GDUM = {{\sum }_{i = 0}}^{I} {GDUM}_{i} .$$

Prediction module 310 then performs a series of calculations to determine the effect of the subsequent day's weather on plant growth. In Block 403, the calculation date is incremented (i=i+1). Block 403 requests that day's weather in Block 404, which returns the data to Block 403. Where the date is in the future, weather data will come from weather prediction data module 303. Where the date is in the past, weather information will come from historical weather data module 304. Block 403 then computes the GDU for day i as

$$GD {U}_{i} = \{ \begin{matrix}\frac{{T}_{max , i} + {T}_{min , i}}{2} - {T}_{base} , & if ( \frac{{T}_{max , i} + {T}_{min , i}}{2} ) > {T}_{b a s e} \\ 0 , & if ( \frac{{T}_{max , i} + {T}_{min , i}}{2} ) \leq {T}_{b a s e}\end{matrix} ,$$

and adds this value to the previous day's total to obtain the GDU. Alternatively, if the field is mulched, a value of M is obtained from current crop data module 320 and GDUM for day i is calculated as

$$G D U {M}_{i} = \{ \begin{matrix}M + \frac{{T}_{max , i} + {T}_{min , i}}{2} - {T}_{base} , & if M + ( \frac{{T}_{max , i} + {T}_{min , i}}{2} ) > {T}_{b a s e} \\ 0 , & if M + ( \frac{{T}_{max , i} + {T}_{min , i}}{2} ) \leq {T}_{b a s e}\end{matrix} ,$$

and adds this value to the previous day's total to obtain the GDUM.

In certain embodiments, weather events that delay growth are taken into account. Thus, the presence or absence of sunshine may affect certain plants. Thus, for example, pollination of the crops by bees can occur only when the sun is shining and the presence or absence of fog may be an important predictive factor.

In an optional embodiment, Block 405 determines if historical or predicted weather events are determined for the calculation date from module 303 or 304, Block 406 determines the effect of the weather event on the variety being calculated is determined from module 305, and Block 407 accepts data from Blocks 405 and 406 and determines if a weather event occurred that would require, for example, that the current stage be reset, which occurs in Block 412. Thus for example, if a cloud cover is preventing pollination of the plants and if the calculated GDU or GDUM is greater that the GDU for the plant for the beginning of the fruit setting stage (GDU=1200 from Table 1, for example), the Block 412 lowers the current value of GDU or GDUM to be equal to 1200. The next step in the method is Block 410 that is discussed subsequently.

If there was no significant weather event, then Block 409 compares the previous date's stage with the current date's GDU or GDUM to determine if that value is sufficient for the plant to move to the next stage that is obtained from Block 408. Thus, referring by way of example to Table I, if the plant was previously in the Plant Developing stage and the GDU or GDUM is now 1201, the current stage is advanced to fruit setting.

If Block 409 determines that the stage has not changed, then the next step in the method is Block 410, which is discussed subsequently. If Block 409 determines that the stage has advanced, then in Block 413, the stage is advanced, Block 414 determines if the stage is the final stage and, if not, the next step in the method is Block 410, which is discussed subsequently. If the stage is the final stage, then the dates for each stage are output to server 120 and eventually to electronic device 110, at Block 415, and module 310 is exited.

In another embodiment, Block 407 accepts data from user G as to the actual phenological stage based on an observation of the plants and determines if the current stage needs to be reset, which occurs in Block 412. Thus, for example and without limitation, in Block 407, user G is prompted by computer 110 to check the field for the current phenological stage of the plant. Thus, for example, user G may perform a visual inspection of the four corners of the irrigation tract and, if plants at three out of four locations have reached a certain stage, then the current phenological stage is input into the system. The current phenological stage is then compared to the predicted stage based on the current date's GDU or GDUM and if there is a difference, resets the system's phenological stage of the plant to an appropriate value of GDU or GDUM in Block 412.

Thus, for example, using Table I as an example, if, based on the current date's GDU or GDUM, the estimated phenological stage is the fruit setting stage (GDU between 1200 and 1300), but the input from user G is that the plants are actually in the earlier, plant developing stage, then Block 412 resets the phenological stage. Using Table I as an example, the phenological stage is reset to the end of the plant developing stage by setting the current date's GDU or GDUM to be less than or equal to 1200, corresponding to near the end of the plant developing stage.

Alternatively, using Table I as an example, if the estimated phenological stage based on the current date's GDU or GDUM is the plant development stage (GDU/GDUM between 1000 and 1200), but the input from user G is that the plants are actually in the later, fruit setting stage, then the phenological stage is reset to the fruit setting stage by setting the current date's GDU or GDUM to a value of 1200. In certain embodiments, system 100 prompts the grower to check the actual phenological stage on a regular basis, such as every day.

Block 410 increments the date. If the date is too far from the transplant date, 200 days, for example, then there has not been sufficient heat to grow the plant and in Block 411, this error is reported to server 120 and eventually to electronic device 110, that the situation planting the variety at the transplant date at the geographic location of the farm—is not realistic and module 310 is exited.

An alternative embodiment of system 300 includes harvest optimization module 340 and allows system 300 to predict transplant dates that will satisfy specified harvest dates.

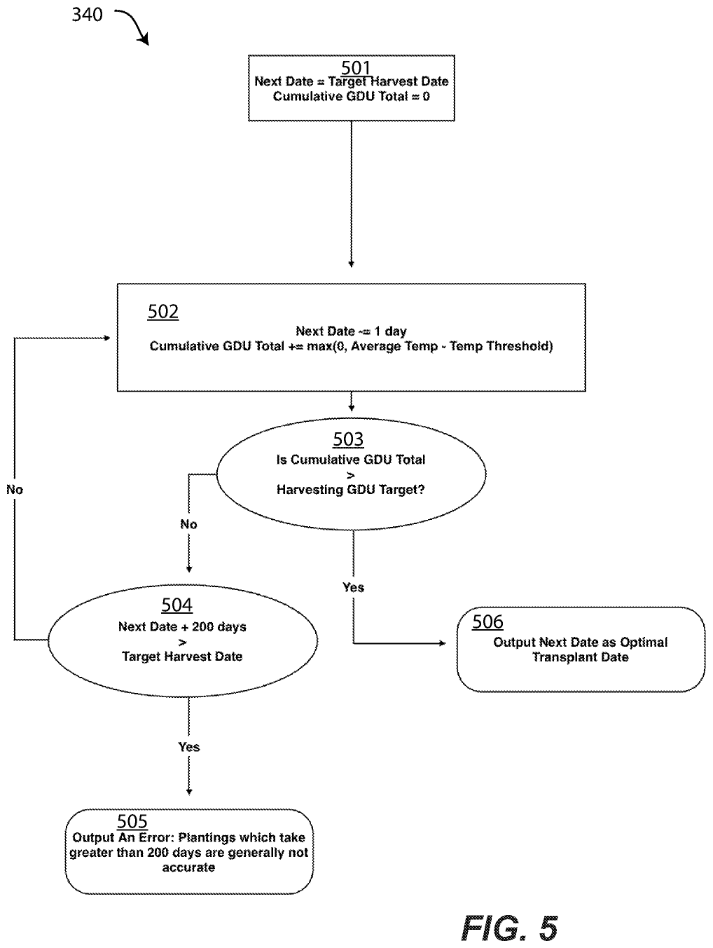

FIG. 5 illustrates one embodiment of harvest optimization module 340. In Block 501, a target harvest date for a particular variety and geographic tract location is obtained from harvest goals from farm and crop data D and variety data is obtained from variety growing data module 305, including a target GDUH for harvesting the crop, such as the number of GDUs at the start of the phenological harvesting stage. As starting point, a first guess at the transplant date is set to be the target harvest date. The method of harvest optimization module 340 proceeds by sequentially setting earlier transplant dates until the GDU from the transplant date to the target harvest date is a target GDUH.

Thus, for example, in Block 502, the transplant date is decreased by one day and the GDU from that transplant date to the target harvest date is calculated. Thus, for example, Block 502 requests weather information covering the period from the transplant date to the target harvest date from weather prediction data module 303. Block 502 then computes the GDU as described above in Harvest Prediction module 310.

In Block 503, the computed GDU or GDUM from Block 502 is compared to the target, GDUH. If the computed GDU or GDUH is less than GDUH then in Block 504, the next calculated growing period is calculated—that is, the number of days from the next calculated transplant date (the current date minus one day) to the target harvest date. If the calculated growing period is too long, 200 days, for example, then there has not been sufficient heat to grow the plant and in Block 505 the error is reported to server 120 and eventually to electronic device 110 that the situation—planting the variety at the transplant date at the geographic location of the farm—is not realistic and module 340 is exited. If, from Block 504, the target GDUH has not been reached, then Block 502 is executed—that is, the transplant date is set a day earlier and the calculation proceeds.

If, in Block 503, the computed GDU or GDUM from Block 502 is greater than the target GDUH, then the calculated transplant date is the optimal transplant date and in Block 506, the optimal transplant date is reported to server 120 and eventually to electronic device 110 and harvest optimization module 340 is exited.

Harvest optimization module 340 may be used to determine optimal transplant dates for one variety, to determine the number of plants which must be transplanted to meet specific goals, such as harvesting a certain number or weight of crops at a target harvest day, and may also be used to determine one or more cuttings of one or more plantings to satisfy goals over a period of time, such as harvesting a specified number or weight according to a harvest schedule.

Thus, in one embodiment, grower G has harvest targets, such as producing a certain amount of watermelon of certain sizes every week from June through July. System 300 may be programmed to accept the harvest goals and the farm information to provide, on electronic device 110, a transplant schedule and one or more cuttings for each tract to meet the harvest goals.

In using system 300, grower G opens a web browser on electronic device 110, accesses server 120 and via programming 330, is presented with a series of pages that prompt the grower for information that then is stored in growing data module 320. Electronic device 110 may, for example, prompt grower G for information D which may include but is not limited to soil type, irrigation block sizes and sensor numbers, other information, such as whether the soil is mulched, and planting dates.

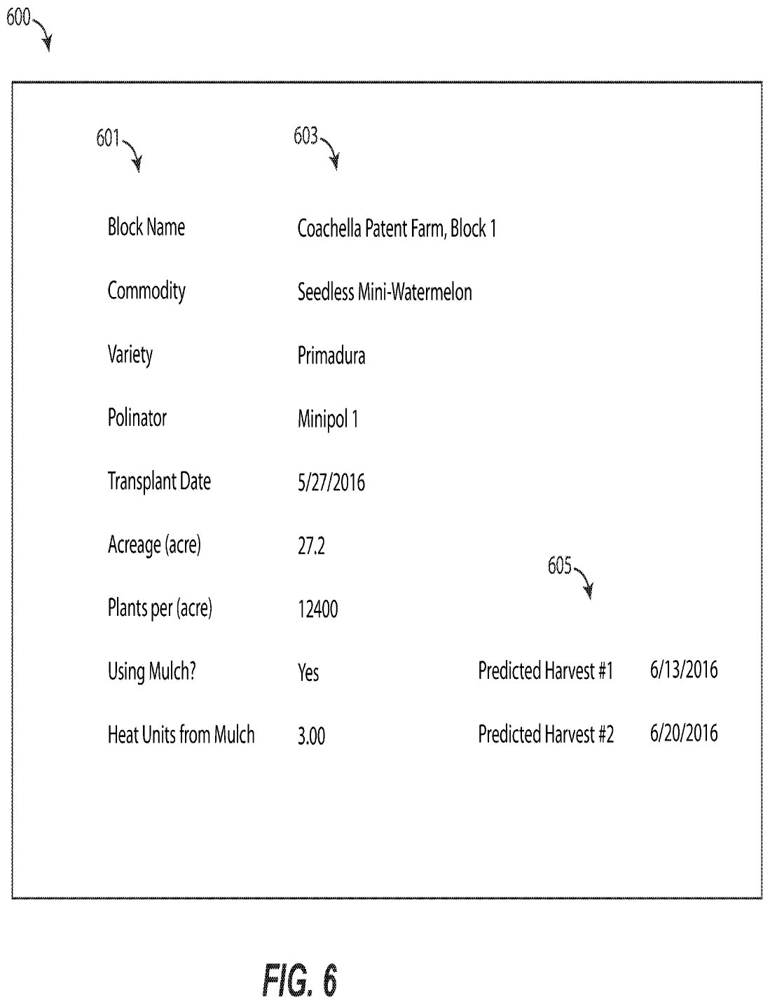

FIG. 6 is an example of a screenshot 600 on device 110 showing prompts 601 and inputs 603 entered into device 110 by grower G. The prompted inputs include: a block name, commodity, variety, pollinator, transplant date, acreage, plants per acre, whether the block is mulched and the number of added heat units for the mulched crops. In certain embodiments, one or more of inputs 603 is in the form of a pull-down menu corresponding to information stored in one of modules 301 or 305. Thus, for example, input 603 may be selected from a pulldown menu of farm locations and/or varieties previously stored in system 300. As described above, system 300 uses the information provided in input 603 to calculate predicted first and second harvests and displays them at output 605.

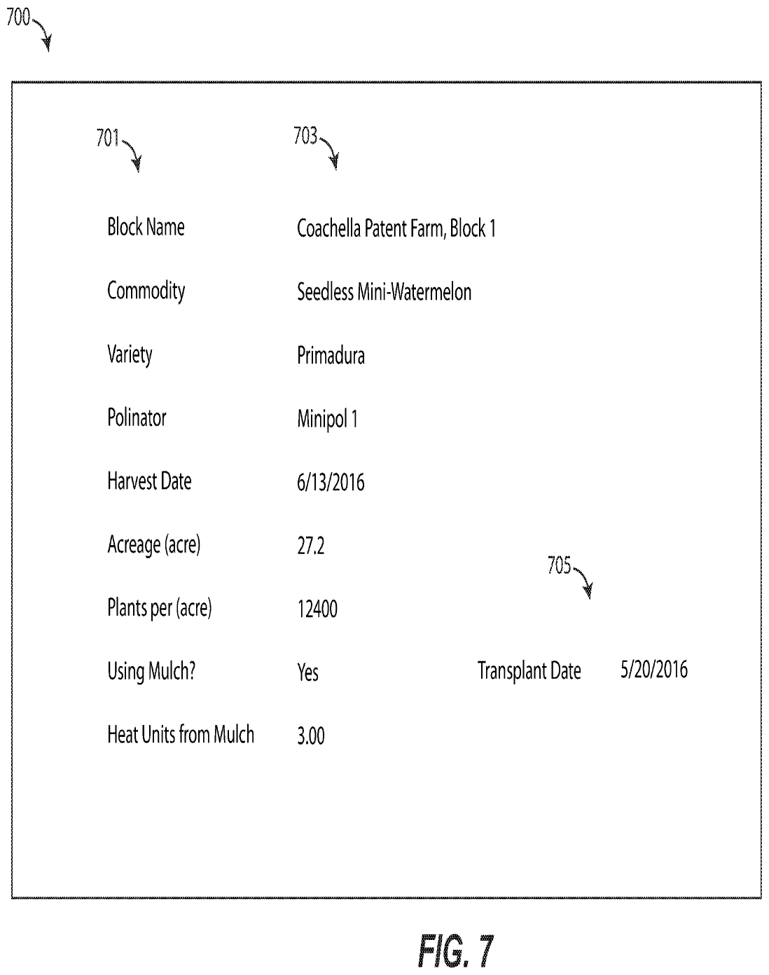

FIG. 7 is an example of a screenshot 700 on device 110 showing prompts 701 and inputs 703 entered into device 110 by grower G to help meet harvesting goals. The prompted input is similar to that of FIG. 6, but includes a target harvest date. As described above, system 300 uses the information provided in input 703 to calculate a transplant date having the target harvest date, and displays the date at output 705.

One embodiment of each of the methods described herein is in the form of a computer program that executes on a processing system, e.g., one or more processors that are part of a networked system. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer-readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer-readable medium may be used including a magnetic storage device such as a diskette or a hard disk or an optical storage device such as a CD-ROM.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner as would be apparent to one of ordinary skill in the art from this disclosure in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

It should further be appreciated that although the coding described herein has not been discussed in detail, the invention is not limited to a specific coding method. Furthermore, the invention is not limited to any one type of network architecture and method of encapsulation, and thus may be utilized in conjunction with one or a combination of other network architectures/protocols.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention. The following claims are by way of example and do not exhaust the various ways in which the invention can be claimed.

1-16. (canceled)

17. A method of crop management of a plant variety to be planted at a geographic by adjusting the amount of moisture in the soil near the plant, where the method uses a system including a computer having a processor, one or more soil moisture sensors located at the geographic location, and an irrigation system having valves operable to deliver water to the geographic location, where the crop has several phonological stages between the transplant date and the harvest phonological stage, where each phonological stage has a predetermined, estimated number of degree growing units at the beginning of the phenological stage and an optimal range of soil moisture for each phonological stage of plant growth, where the processor is programmed to determine the operation of the valves based on soil moisture levels determined from measurements from one or more soil moisture sensors, and where the processor is programmed to access predicted temperature data from a Prediction Weather Data Module, and historical temperature data from a Historical Weather Data Module, said method comprising:
determining one or more stakeholders involved in harvesting or transporting the crop to the point of consumption and whose activities depend on advance notice of a harvest date, where the one or more stakeholders include harvesters of the crop, shipping vendors who arrange for shipping the produce from the geographic location, and buyers who accept the vendors' shipments and distribute the produce to stores or others who supply the crop produce to consumers,
calculating a transplant date at the geographic location based on a desired harvest date using predicted temperature data at the geographic location from the Prediction Weather Data Module;
transplanting the crop on the calculated transplant dale, for one or more current dates after the calculated transplant date,
determining the number of growing degree units between the transplant date and the current date using the historical data from the Historical Weather Data Module,
estimating the current phenological stage from the determined number of growing degree days, the historical data from the Historical Weather Data Module, and the predetermined number of degree growing units at the beginning of each phonological stage,
determining a range of optimal soil moisture levels corresponding to the estimated phenological stage,
determining the current soil moisture percentage (SMP) in the soil,
operating the valves to provide water to the soil if the current SMP is less than the range of optimal soil moisture levels,
calculating a predicted harvest, date using the calculated number of growing degree units and the predicted temperature data from the prediction weather data module, and
providing the predicted harvest dates to the one or more stakeholders involved in harvesting and transporting the crops to the point of consumption.

18. The method of claim 17,
where said determining the number of growing degree units is corrected for mulching; and
where said estimating the current phenological stage estimates based on the determined number of growing degree units corrected for mulching.

19. The method of claim 17,
where the soil has a saturation percentage (SP), and
where said determining the current SMP in the soil comprises:
receiving an output of a soil moisture sensor as a Volumetric Water Content (VWC) of the soil; and calculating the solid moisture percentage as SMP=VWC/SP.

20. An apparatus for crop management of a plant variety to be planted at a geographic location by adjusting the amount of moisture in the soil near the plant, where the method uses a system including a computer having a processor, one or more soil moisture sensors located at the geographic geographic location, where the crop has several phenological stages between the transplant date and the harvest phonological stage, where each phenological stage has a predetermined, estimated number of degree growing units at the beginning of the phonological stage and an optimal range of soil moisture tor each phonological stage of plant growth, where the processor is programmed to determine the operation of the valves based on soil moisture levels determined from measurements from one or more soil moisture sensors, and where the processor is programmed to access predicted temperature data from a Prediction Weather Data Module, and historical temperature data from a Historical Weather Data Module, said apparatus comprising a computer having a processor programmed to:
determine one or more stakeholders involved in harvesting or transporting the crop to the point of consumption and whose activities depend on advance notice of a harvest date, where the one or more stakeholders include harvesters of the crop, shipping vendors who arrange for shipping the produce from the geographic location, and buyers who accept the vendors' shipments and distribute the product to stores or others who supply the crop produce to consumers,
calculate a transplant date at the geographic location based on a desired harvest date using predicted temperature data at the geographic location from the Prediction Weather Data Module;
receive a confirmation that the crop was transplanted on the calculated transplant date;
for one or more current dates after the calculated transplant date,
determine the number of growing degree units between the transplant date and the current date using the historical data from the Historical Weather Data Module,
estimate the phenological stage from the determined number of growing degree days, the historical data from the Historical Weather Data Module, and the predetermined number of degree growing units at the beginning of each phenological stage,
calculate a predicted harvest date using the determined number of growing degree units and the predicted temperature data from the Prediction Weather Data Module,
provide the predicted harvest date to the one or mote stakeholders involved in harvesting and transporting the crops to the point of consumption,
determine a range of optimal soil moisture levels corresponding to the estimated phenological stage,
determine the current soil moisture percentage (SMP) in the soil, and
providing instructions to water the soil if the current SMP is less than the range of optimal soil moisture levels.

21. The apparatus of claim 20, where said processor is further programmed to:
determine the number of growing degree units corrected for mulching; and
estimate the current phenological stage based on the determined number of growing degree units corrected for mulching.

22. The apparatus of claim 20, where said processor is further programmed to:
receive an output of a soil moisture sensor as a Volumetric Water Content (VWC) of the soil; and
calculate the solid moisture percentage as SMP VWC/SP.

23-30. (canceled)

31. The method of claim 17, where the method further includes, for one or more current dates after the calculated transplant date,
observing a transition to a beginning of a phenological stage of the plant variety at the geographic location at a transition date, and
where the determining the number of growing degree units between the transplant date and the current date corrects for the observed transition by determining the number of growing degree units as the predetermined number of degree growing units at the beginning of the phenological stage plus the number of degree growing units from the transition date to the current date using the historical data from the Historical Weather Data Module.

32. The method of claim 17, where said provide the predicted harvest date is provided daily to at least one of the one or more stakeholders.

33. The method of claim 17, where the valves are operated manually according to the indication.

34. The method of claim 17, where the valves are operated automatically according to the indication.

35. The apparatus of claim 20, where the processor is further programmed to, for one or more current dates after the calculated transplant date,
accept the observation of an observed transition to a beginning of a phenological stage of the plant variety at the geographic location at a transition date, and
where the processor is programmed to determine the number of growing degree units between the transplant date and the current date corrected for the observed transition from the number of growing degree units as the predetermined number of degree growing units at the beginning of the phenological stage plus the number of degree growing units from the transition date to the current date using the historical data from the Historical Weather Data Module.

36. The apparatus of claim 20, where the processor is programmed to provide the predicted harvest date daily to at least one of the one or more stakeholders.

37. The apparatus of claim 20, where the valves are operated manually according to the indication.

38. The apparatus of claim 20, where the processor is further programmed to operate the valves automatically according to the indication.
